(19) United States
(12) Patent Application Publication
(10) Pub. No.: US 2026/0230267 A1
(43) Pub. Date: Aug. 6, 2026

(54) A METHOD FOR CONFIGURING RESOURECES FOR SIDELINK REFERENCE SIGNALS FOR POSITIONING, RELATED RADIO NETWORK NODE AND RELATED WIRELESS DEVICE

(71) Applicant: Sony Group Corporation, Tokyo (JP)

(72) Inventors: Basuki PRIYANTO, Lund (SE); Naoki KUSASHIMA, Basingstoke (GB); Anders BERGGREN, Lund (SE); Jose FLORDELIS, Lund (SE); Johan HILL, Lund (SE)

(21) Appl. No.: 19/153,180

(22) PCT Filed: Feb. 2, 2024
(86) PCT No.: PCT/EP2024/052652

§ 371 Date: Aug. 1, 2025

(30) Foreign Application Priority Data
Feb. 16, 2023 (SE) 2350175-2

(51) Int. Cl. H04L 5/00; H04W 64/00; H04W 72/40

(52) U.S. Cl. CPC H04L 5/0051; H04L 5/0007; H04L 5/0094; H04W 64/00; H04W 72/40

(57) ABSTRACT

Disclosed is a method, performed in a radio network node, for configuring resources for sidelink reference signals for positioning. The method comprises transmitting, to a wireless device, control information associated with a sidelink positioning procedure. The control information is indicative of an allocation of resources for transmission of sidelink reference signals for positioning by a plurality of wireless devices participating in the sidelink positioning procedure.

The present disclosure pertains to the field of wireless communications. The present disclosure relates to a method for configuring resources for sidelink reference signals for positioning, a related radio network node, and a related wireless device.

### BACKGROUND

Positioning is an important feature of the 3rd Generation Partnership Project (3GPP) Fifth Generation (5G) New Radio (NR), targeting high accuracy positioning of wireless devices. The radio access technology (RAT) dependent positioning in 3GPP has been established by utilizing reference signals transmission using an interface between a radio network node and a wireless device (WD), which interface may be referred to as a direct-link (or Uu interface). For positioning in NR, sidelink (SL) positioning has been considered as an alternative to direct-link positioning.

### SUMMARY

In SL, resources, such as sub-channels, can be allocated for one-to-one (e.g., unicast, one resource for one WD) and one-to-many (e.g., groupcast and/or broadcast, and/or one resource for many WDs). For positioning purposes, the transmission of SL reference signals for positioning (SL-PRS) is needed for positioning measurement and estimation. Transmission of SL reference signals for positioning from multiple WDs (for example many-to-one, many-to-many, or one-to-many) are required for multi-lateration in the position estimation process. However, there is a need for improving the resource allocation, and allowing multiple WDs to occupy common resource(s) for positioning within a sidelink framework.

Accordingly, there is a need for devices and methods for configuring resources for sidelink reference signals for positioning and for communicating sidelink reference signals for positioning with one or more second WDs, which may mitigate, alleviate or address the shortcomings existing and may provide an improved resource allocation supporting transmission of SL reference signals for positioning from multiple WDs in sidelink transmission while maximizing the resource utilization.

Disclosed is a method, performed in a radio network node, for configuring resources for sidelink reference signals for positioning. The method comprises transmitting, to a wireless device, control information associated with a sidelink positioning procedure. The control information is indicative of an allocation of resources for transmission of sidelink reference signals for positioning by a plurality of wireless devices participating in the sidelink positioning procedure.

Further, a radio network node is provided. The radio network node comprises memory circuitry, processor circuitry, and a wireless interface. The radio network node is configured to perform any of the methods disclosed herein.

It is an advantage of the present disclosure that the disclosed method and the disclosed radio network node provide a configuration of the resources for SL reference signals for positioning which enables an improved resource allocation supporting transmission of SL reference signals for positioning from multiple WDs in sidelink transmission while maximizing the resource utilization. In other words, the disclosed radio network node allows an SL reference signal configuration to a single WD for the reception of SL reference signals from multiple SL transmitting WDs, wherein the SL reference signals are to be transmitted in a common resource(s) (e.g., sub-channel, group of resources). Furthermore, a single WD can perform simultaneous positioning measurements towards multiple SL transmitting WDs when the SL reference signals are in a common resource(s).

Disclosed is a method, performed in a first wireless device for communicating sidelink reference signals for positioning with one or more second wireless devices. The method comprises receiving, from a radio network node, control information associated with a sidelink positioning procedure. The control information is indicative of an allocation of resources for transmission of sidelink reference signals for positioning by a plurality of wireless devices participating in a sidelink positioning procedure. The method comprises performing, based on the control information, the sidelink positioning procedure with the one or more second wireless devices.

Further, a wireless device is provided. The wireless device comprises memory circuitry, processor circuitry, and a wireless interface. The wireless device is configured to perform any of the methods disclosed herein.

It is an advantage of the present disclosure that the disclosed method and the disclosed wireless device benefit from configuring the sidelink positioning procedure so that the wireless device can receive SL reference signals from a plurality of WDs participating in the sidelink positioning procedure. This may result in an overall improved resource allocation and reduced power consumption for the disclosed wireless device. The wireless device can also perform positioning measurements towards plurality of WDs participating in the sidelink positioning procedure.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example wireless device according to this disclosure,

FIG. 2 is a diagram illustrating a resource pool for sidelink transmissions,

FIG. 3 is a diagram illustrating a legacy sidelink resource pool and its elements,

FIG. 4 is a diagram illustrating an allocation of resources for transmitting sidelink reference signal configurations for positioning and resources for transmitting sidelink reference signals for positioning in a resource pool according to this disclosure

FIG. 5 is a diagram illustrating time domain multiplexing of multiple resources for sidelink reference signal configurations for positioning and multiple resources for transmitting sidelink reference signals for positioning according to this disclosure,

FIG. 6 is a diagram illustrating a sidelink resource allocation where a sub-channel is divided for the resources for transmitting sidelink reference signal configuration for positioning according to this disclosure,

FIG. 7 is a diagram illustrating a sidelink resource pool having an aggregated sub-channel for carrying sidelink reference signals for positioning according to this disclosure,

FIG. 8 is a diagram illustrating a sidelink resource pool for sidelink reference signals for positioning for resource allocation mode 1 according to this disclosure,

FIG. 9 is a diagram illustrating a mapping of sidelink transmission resources for configuration and sidelink transmission resources for reference signals for positioning according to this disclosure,

FIG. 10 is a diagram illustrating an example resource allocation for semi-persistently transmitted sidelink reference signals for positioning according to this disclosure,

FIG. 11 is a diagram illustrating an example scenario where one sidelink reference signal configuration containing the configurations of multiple SL TX WDs is transmitted according to this disclosure,

FIG. 12 is a flow-chart illustrating an example method, performed in a radio network node, for configuring resources for sidelink reference signals for positioning, according to this disclosure,

FIG. 13 is a flow-chart illustrating an example method, performed in a first wireless device, for communicating sidelink reference signals for positioning with one or more second wireless devices, according to this disclosure,

FIG. 14 is a block diagram illustrating an example radio network node according to this disclosure,

FIG. 15 is a block diagram illustrating an example wireless device according to this disclosure,

FIG. 16 is a signaling diagram illustrating an example communication between a network node and a first wireless device and a second wireless device according to this disclosure, and

FIG. 17 is a signaling diagram illustrating an example communication between a first wireless device and a second wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

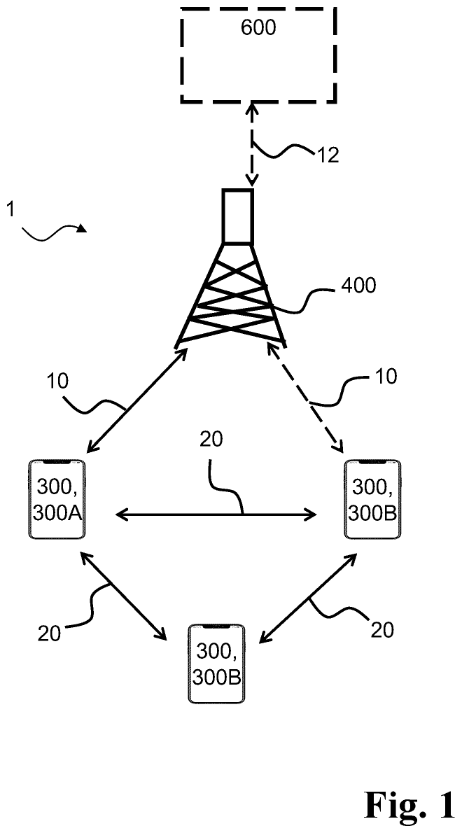

FIG. 1 is a diagram illustrating an example wireless communication system 1 comprising an example radio network node 400, an example core network node 600, and one or more wireless device(s) 300, such as an example target wireless device 300A, and an example assisting WD 300B according to this disclosure. The wireless devices 300, such as the target wireless device 300A and the assisting wireless devices 300B may be different types of wireless devices, such as a Vulnerable Road User (VRU) WD, a Road Side Unit (RSU) WD and a vehicle WD. In one or more examples, the target wireless device 300A is a moving WD, such as a VRU WD or a vehicle WD. In one or more examples, the assisting wireless device 300B is a WD having a known, such as a fixed location, such as an RSU WD or a second moving WD, such as a second vehicle WD and/or a second VRU WD. As discussed in detail herein, the present disclosure relates to a wireless communication system 1 comprising a cellular system, for example, a 3GPP wireless communication system. The VRU WD may be a WD, such as a mobile phone or other device, being in possession of pedestrian or a biker. The RSU may be a static mounted WD, such as a WD mounted on a traffic sign and/or a lamp post.

A radio network node disclosed herein refers to a radio access network node operating in the radio access network, such as a base station, an evolved Node B, eNB, gNB in NR. In one or more examples, the RAN node is a functional unit which may be distributed in several physical units. A radio network node has at least one transmission and reception point (TRP) for the communication with the wireless device(s).

A core network, CN, node disclosed herein refers to a network node operating in the core network, such as in the Evolved Packet Core Network, EPC, and/or a 5G Core Network, 5GC. Examples of CN nodes in EPC include a Mobility Management Entity, MME and/or a positioning node, such as a Location Management Function (LMF).

In one or more examples, the CN node is a functional unit which may be distributed in several physical units.

The wireless communication system 1 described herein may comprise one or more wireless devices 300, and/or one or more radio network nodes 400. The radio network nodes may be one or more of a base station, an eNB, a gNB and/or an access point. The one or more WDs 300 may comprise moving WDs, such as vehicles and/or VRUs (pedestrians, bikers, etc.), and WDs having fixed locations, such as RSUs.

A WD may refer to a mobile device and/or a user equipment (UE).

The one or more wireless devices 300 may be configured to communicate with the network node 400 via a wireless link (or radio access link) 10. The wireless link 10 may be set up via a Uu interface between the one or more WDs and the radio network node 400.

The core network node 600 may be configured to communicate with the radio network node 400 via a link 12, such as a wired and/or wireless link, and/or with the one or more wireless devices 300, 300A, via the radio network node 400.

The wireless devices 300, 300A, 300B may be configured to communicate directly with each other via a sidelink 20, such as without communicating via the radio network node 400. The sidelink 20 may be a wireless link, such as via a PC5 interface.

Positioning of one or more of the WDs 300 may be performed using different techniques, such as sidelink positioning and/or direct-link positioning. The sidelink positioning uses the PC5 interface, such as the sidelink 20, to communicate sidelink reference signals for positioning between a plurality of WDs 300. The direct-link positioning uses the Uu interface between the WD to be positioned and one or more radio network nodes, such as the wireless link 10.

During sidelink positioning, there are two types of WDs that are interacting, as described in 3GPP TR 38.859 Version 18.0.0. The first type of WD is the WD to be positioned, which may herein be referred to as a target WD 300A. The term target WD can be used for the WD to be positioned both in sidelink positioning and/or direct-link positioning. The second type of WD interacting during the sidelink positioning is a WD supporting positioning of target UE, for example by transmitting and/or receiving reference signals for positioning and/or providing positioning-related information over the SL interface. The second type of WD may herein be referred to as an assisting WD 300B. The assisting WD is a WD assisting the target WD in the positioning procedure. The assisting WD may have a known, such as a fixed location, or may be a moving WD, such as a WD having a position that varies over time. When the assisting WD meets certain requirements, such as when the position and/or location is known or fixed, the assisting WD 300B may be referred to as an anchor WD, in accordance with 3GPP TR 38.859.

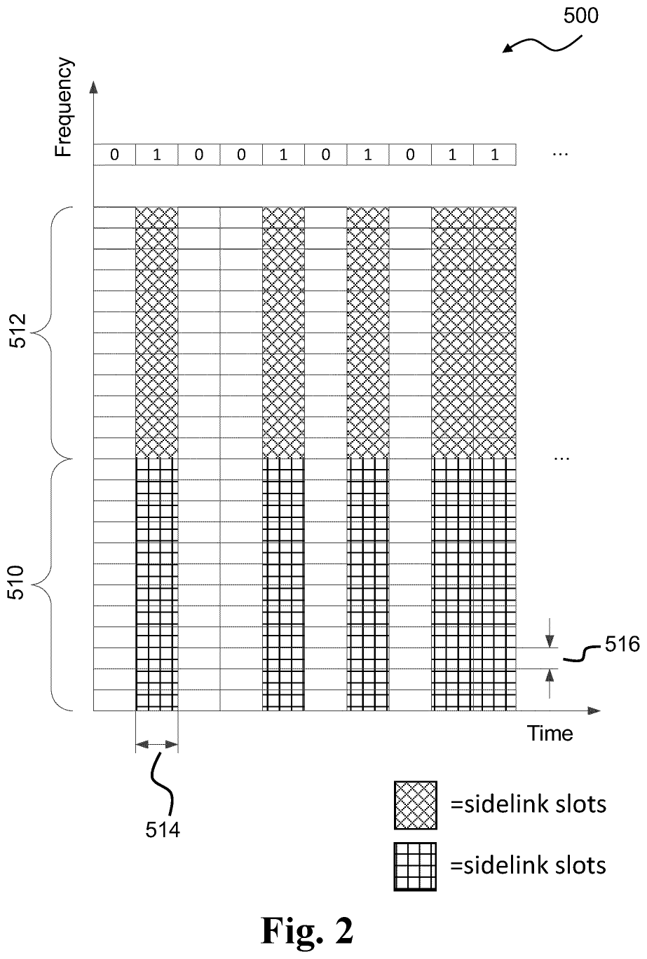

The sidelink transmission between WDs is arranged within a resource pool, such as a time and frequency resource pool. FIG. 2 illustrates an example resource pool 500 for sidelink transmission. In the frequency domain, the resource pool is divided into one or more sub-channels 510, 512 by parameters that indicate a starting physical resource block (PRB) 516, a number of sub-channels comprised in the resource pool, and a sub-channel size. In the time domain, the resource pool is configured by a bitmap, where each bit of the bitmap corresponds to one uplink slot 514. Hence, a resource pool consists of one or more sub-channels 510, 512 (in the frequency domain) and one or more time slots 514 (in the time domain). The example resource pool of FIG. 2 comprises two sub-channels, such as a first sub-channel 510 and a second sub-channel 512, and ten slots in the time domain. However, only five slots are configured for sidelink purposes in each sub-channel (as indicated by bitmap ‘1’ in FIG. 2). Each slot comprises a plurality of symbols, such as fourteen symbols. The other slot(s) can be used for other purposes.

A resource pool may be pre-configured and/or configured via a system information block (SIB), or a dedicated radio resource control (RRC) message to the WD. A sidelink transmission resource is defined as one sub-channel and one sidelink slot. A transmission from a WD occupies a sub-channel, such as at least one sub-channel.

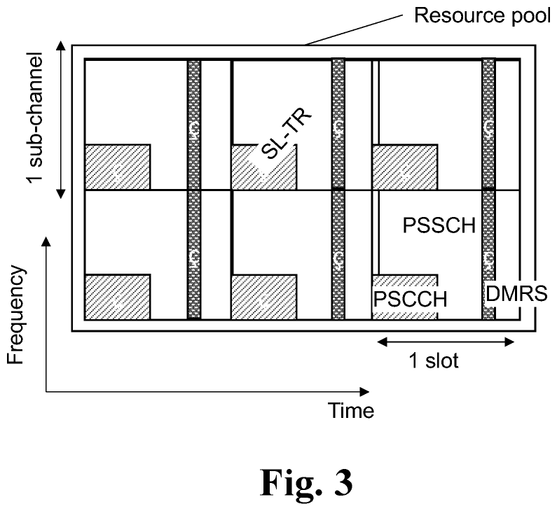

FIG. 3 illustrates a legacy sidelink resource pool. The legacy sidelink transmission resource comprises one or more of a Physical Sidelink Control Channel (PSCCH), a Physical Sidelink Shared Channel (PSSCH), a Demodulation Reference Signal (DMRS) for PSCCH and PSSCH, an Automatic Gain Control (AGC) symbol, and a Physical Sidelink Feedback Channel (PSFCH), if configured; see FIG. 3. The AGC symbol is located in the first symbol of the slot, and is copied from the second symbol. In other words, the AGC symbol is the same in the first and second symbol. The PSCCH is allocated from the lowest Physical Resource Block (PRB) in the sub-channel, from the second to the third or fourth symbols in the slot. The number of DMRS symbols for PSSCH may be two, three, or four. The position of the DMRS may be configured by higher layer signaling, such as RRC signaling. The last symbol in the slot (such as the fourteenth symbol) is always empty, for the purpose of Tx-Rx switching, avoiding interference caused by transmission timing misalignment, etc. PSFCH is used to transmit sidelink hybrid-automatic repeat request (HARQ)-acknowledgment (ACK) and may be located in the thirteenth symbol if PSFCH transmission has been configured. In this case, the symbol before the PSFCH symbol (i.e., the twelfth symbol) may become an empty symbol. The remaining resource elements (REs), except for PSCCH, DMRS, PSFCH, AGC symbol, and empty symbol, are allocated by PSSCH. The symbols mentioned herein may be Orthogonal Frequency Division Multiplexing (OFDM) symbols.

Sidelink transmissions may use a two-stage control information structure for transmitting sidelink control information (SCI). A first stage sidelink control information (SCI format 1-x) may be conveyed by PSCCH, while a second stage SCI (SCI format 2-x) may be conveyed by using a part of PSSCH. The first stage SCI contains information about the sidelink transmission resources, reservation resource information, and information necessary to decode PSSCH. The second-stage SCI contains the remaining information.

Two resource allocation (RA) modes have been defined for sidelink, RA mode 1 and RA mode 2. In RA mode 1, the radio network node, such as an eNB or gNB, schedules sidelink resource(s) to be used by a WD for sidelink transmission. In RA mode 2, a WD determines sidelink transmission resource(s) within the resource pool (such as autonomously by the WD).

To avoid collisions between different sidelink transmissions, sensing and resource selection procedures may be supported for RA mode 2. The sensing procedure is defined as decoding SCI from other WDs or measuring a power, such as a reference signal received power (RSRP), of sidelink transmissions from other WDs. By decoding SCI from other WDs, a WD can be made aware of the resource(s) planned to be used for SL transmissions by other WDs and can consider these resource(s) as non-available during the resource selection procedure.

For sidelink positioning, the target WD(s) may have to receive sidelink reference signals for positioning from a plurality of WDs within a positioning measurement occasion. At the same time, the resource structure for transmitting sidelink reference signals is typically sparse in the frequency domain, forming a comb-like structure. In this case, multiple sidelink reference signals for positioning from different transmitting WDs can occupy different sub-carriers, or resource elements (REs), within a symbol.

In the legacy NR sidelink, the only resources that multiple WDs can share are resources within a resource pool. Multiple WDs can be assigned with different, such as respective, SL-transmission resources within one or more resource pools. This implies that a SL-transmission resource is allocated to one sidelink-transmitting WD (SL-Tx-WD) and one or more sidelink-receiving-WD(s) (SL-Rx-WD(s)). Allocating an entire SL transmission resource, such as resource pool, for transmission of sidelink reference signals for positioning from a SL-Tx-WD is not efficient as the allocation of sidelink reference signals for positioning from a SL-Tx-WD may not occupy the entire symbol. Therefore, within an OFDM symbol, multiple sidelink reference signals for positioning may be multiplexed to provide a more efficient use of the available resources.

The current disclosure provides resource allocations for supporting transmission of sidelink reference signals from multiple SL-Tx WDs, which improve the resource utilization in sidelink. The current disclosure further provides a solution for conveying a sidelink reference signal configuration for positioning to a single WD, such as to a target WD, for enabling the target WD to receive sidelink positioning reference signals for positioning from a plurality of SL-Tx-WDs in a common resource, such as sub-channel or a group of resources, carrying the sidelink reference signals for positioning. The solution provided herein provides collision avoidance, such as avoids multiple SL-Tx-WDs using the same PSCCH resource.

According to the current disclosure, common resources for transmission of sidelink reference signals for positioning can be allocated by one or more SL-Tx-WDs. A configuration related to the sidelink reference signals for positioning, herein also referred to as sidelink reference signal configurations for positioning, may be provided outside of the common resources for transmission of the sidelink reference signals for positioning. The solution according to the current disclosure, will be described in detail in the following.

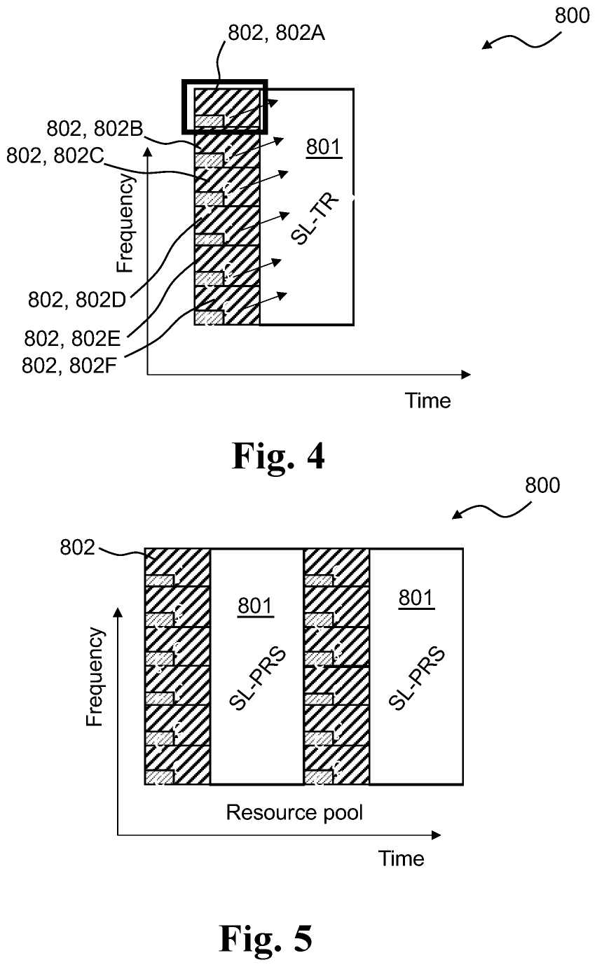

In one or more example methods, the SL-Tx-WD provides the sidelink reference signal configurations for positioning to the SL-Rx-WD via a sidelink transmission resource, as shown in FIG. 4. FIG. 4 shows a resource pool 800 for sidelink transmission in which a subset of the resources 802 is allocated for transmission of the sidelink reference signal configurations for positioning. In one or more example methods, each SL-Tx-WD has its own sidelink transmission resource 802A-F carrying the WD-specific sidelink reference signal configuration for positioning. The sidelink transmission resources 801 for the transmitting WDs may be multiplexed in the frequency domain. This solution may for example be applicable when a SL-Tx-WD is to transmit sidelink reference signals for positioning aperiodically, for example triggered by an event. The sidelink reference signals for positioning can be allocated/transmitted immediately, such as in an earliest possible subsequent symbol from transmission of the sidelink positioning reference signal configuration, after the reception of the configuration. The size of the resource 801 for transmitting sidelink reference signals for positioning can also be adjusted dynamically according to the need.

FIG. 5 shows a sidelink resource allocation according to one or more example methods, in which resources for transmitting the sidelink reference signal configurations for positioning and resources for transmitting sidelink reference signals for positioning are multiplexed in the time-domain. In one or more examples, the resource pool 800 can comprise two sidelink transmission resource, a first sidelink transmission resource type 802 carrying the sidelink reference signal configurations for positioning and a second sidelink transmission resource type 801 carrying sidelink reference signals for positioning. The two sidelink transmission resource types, such as the first sidelink transmission resource type 802 and the second sidelink transmission resource type 801, may be multiplexed in the time domain, as shown in FIG. 5.

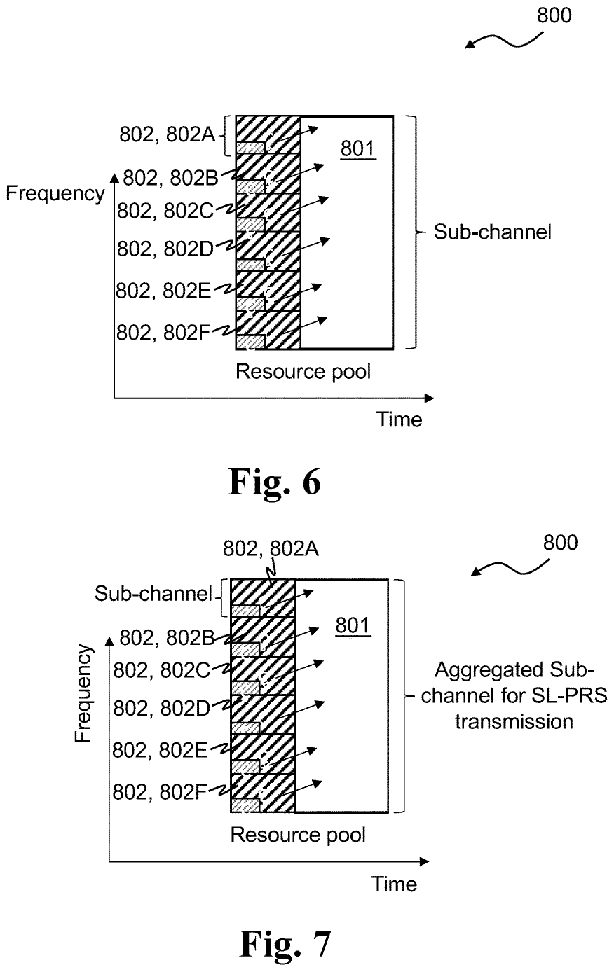

FIG. 6 shows a resource allocation according to one or more examples of this disclosure, in which a sub-channel is divided for the resources 802, 802A-F for transmitting sidelink reference signal configuration for positioning. The entire sub-channel, such as frequency resources corresponding to the entire sub-channel, is used for transmitting sidelink reference signals for positioning 801. For this example, a new frequency resource unit for transmitting the sidelink reference signal configuration for positioning carried by 1st and 2nd-stage SCI may be defined. The new frequency resource unit may be derived from a sub-channel divided by the number of frequency offsets of a comb structure for sidelink reference signals for positioning. In the example shown in FIG. 6, the number of frequency offsets of the comb structure for sidelink reference signals for positioning is six. Correspondingly, six sidelink transmission resources (SL-TR) 802 for sidelink reference signal configuration for positioning are contained within one sub-channel. Each sidelink reference signal configuration 802A-F for positioning indicates respective resources for sidelink reference signal transmission which occupy the common resources 801 of the sub-channel.

FIG. 7 shows a resource allocation according to one or more examples of this disclosure, in which the respective dedicated resources 802, 802A-F for transmission of the sidelink reference signal configuration for the plurality of SL-Tx-WDs is allocated to a respective sub-channel. The resources for transmission of the sidelink reference signal configuration is associated with each sub-channel and the shared resources 801 for transmitting the sidelink positioning reference signals is allocated for all sub-channels in which corresponding sidelink positioning reference signal configuration are allocated. In the example shown in FIG. 7, the sidelink resource pool 800 is divided into six sub-channels, such as six SL-TR for transmission of sidelink reference signal configurations for positioning. The six sub-channels may correspond to the number of frequency offsets of the comb-structure. A respective sidelink reference signal configuration for positioning may be transmitted using the respective sub-channel. The sidelink reference signal transmission for the plurality of sidelink reference signal configurations are transmitted in an aggregated sub-channel where the six sub-channels of the sidelink reference signal configurations are aggregated. The resource allocation of FIG. 7 differs from the resource allocation in Fig. in that the respective dedicated resources for transmission of sidelink reference signal configurations for positioning in FIG. 7 occupy a respective sub-channel and the shared resources for transmission of sidelink reference signals in FIG. 7 occupy an aggregated sub-channel corresponding to the aggregation of the respective dedicated resources for transmission of sidelink reference signal configurations. In FIG. 6, the shared resources for transmission of sidelink reference signals occupy a sub-channel, and the respective dedicated resources for transmission of sidelink reference signal configurations occupy a subset of the same sub-channel.

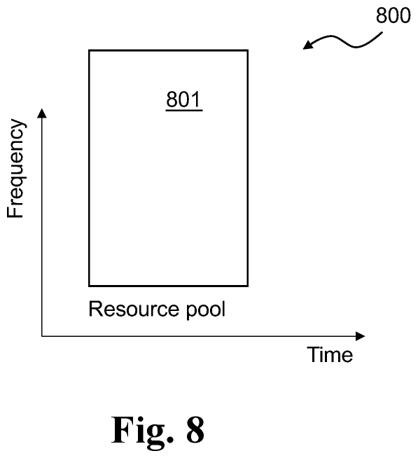

FIG. 8 shows a resource allocation according to one or more examples of this disclosure, in which the sidelink reference signal configuration is provided to the sidelink WDs by the radio network node. The sidelink reference signal configuration may be provided using an RRC configuration. In this case, both the SL-Tx-WD(s) and the SL-Rx-WD(s) may receive the configuration from the radio network node. Both the SL-Tx-WD(s) and the SL-Rx-WD(s) may receive related dedicated RRC messages from the radio network node. This example method may be used when the sidelink reference signals for positioning are transmitted periodically, for example when the transmitting WD is an RSU. Other scenarios where the sidelink reference signal configuration may be provided to one or more WDs by the radio network node may be when the sidelink reference signal configuration is static or semi-static, such as when the configuration rarely changes, and/or when different SL-Tx-WDs transmit sidelink reference signals for positioning with a similar sidelink reference signal configuration. In one or more example methods, when the sidelink reference signal configuration is provided from the radio network node, such as by RRC configuration, the one or more SL-Tx-WD(s) may transmit sidelink reference signals for positioning without prior transmission of SCI, as shown in FIG. 8. In other words, a larger portion of the sidelink resource pool 800, such as the entire resource pool 800, may be allocated to shared resources 801 for transmission of sidelink reference signals for positioning from the one or more SL-Tx-WD(s).

In one or more example methods, the sidelink reference signal configuration for positioning comprised in a first SL-TR 802 may configure a second SL-TR 801 carrying sidelink reference signals for positioning within the same slot as the first SL-TR, as shown in FIGS. 4-7.

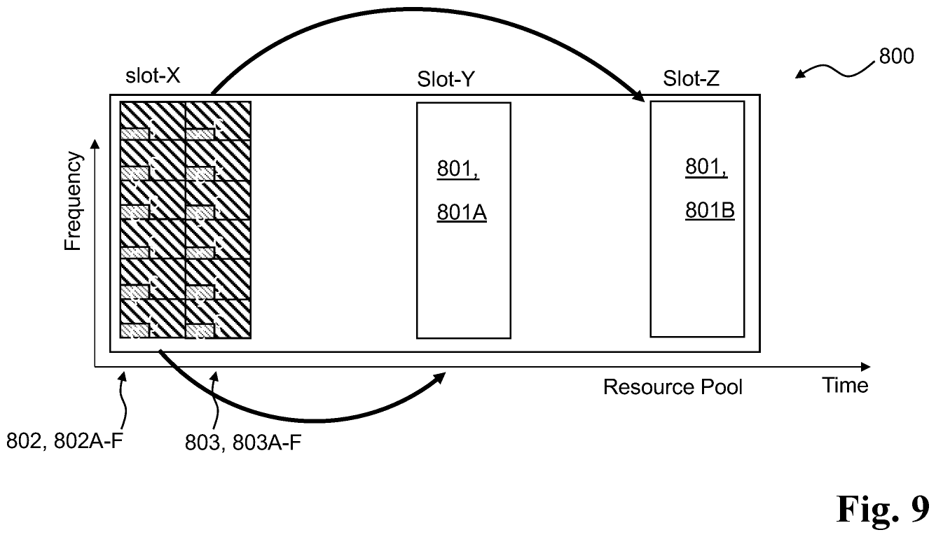

In one or more example methods, the sidelink reference signal configuration for positioning comprised in a first SL-TR 802 may configure a second SL-TR 801 carrying sidelink reference signal for positioning in a second slot, as shown in FIG. 9. As can be seen in FIG. 9, a first SL-TR in a first part of a first slot, in FIG. 9 referred to as Slot-X, may contain sidelink reference signal configurations for transmission of sidelink reference signals in a second SL-TR 801, 801A in a second slot, in FIG. 9 referred to as Slot-Y. A second SL-TR 803, 803A in a second part of the first slot, such as a second part of Slot-X, may contain sidelink reference signal configurations for transmission of sidelink reference signals in a third SL-TR 801, 801B in a third slot, in FIG. 9 referred to as Slot-Z. In other words, the first part of the sub-channels in Slot-X contains the configuration of sidelink reference signals for positioning in Slot-Y. Correspondingly, the second part of the sub-channels in Slot-X contains the configuration of sidelink reference signals for positioning in Slot-Z.

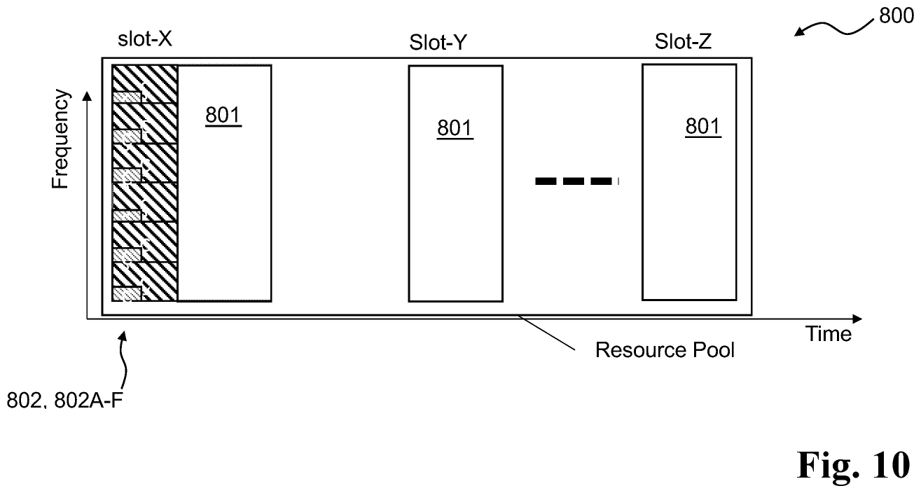

FIG. 10 shows an example resource allocation for sidelink reference signals for positioning, in which sidelink reference signals for positioning are semi-persistently transmitted. In other words, SL-TR 801 for transmission of sidelink reference signals may be semi-persistently scheduled. The semi-persistent scheduling may be across different resource pools 800 or different slots within a resource pool 800. The scheduling pattern may be indicated in the sidelink reference signal configuration allocated in a first part, such in a first subset of symbols in Slot-X. The sidelink reference signal configuration may indicate the It can be across different resource pool or slot (within a resource pool). In this case, PSCCH or PSSCH carrying the sidelink reference signal configuration may indicate an activation and/or deactivation for semi-persistent transmission of the sidelink reference signals.

In one or more example methods, the SL-TR 802, 803 for transmitting the sidelink reference signal configuration for positioning are carried by PSCCH and PSSCH.

In one or more example methods, the sidelink reference signal configuration for positioning, such as the PSCCH of the SL-TR 802, 803 for transmitting the sidelink reference signal configuration for positioning, comprises one or more sidelink reference signal parameters for positioning enabling SL-Rx-WD to receive and decode PSSCH.

In one or more example methods, the sidelink reference signal configuration for positioning, such as the PSCCH of the SL-TR for transmitting the sidelink reference signal configuration for positioning, comprises differentiation between legacy SCI format 2 (SCI format 2-A, 2-B, and 2-C) and new SCI format 2 carrying SL-TR for transmission of the sidelink reference signal configuration for positioning (such as SCI format 2-D). This differentiation information may be indicated by a field of “2nd-stage SCI format” in an SCI format 1-A.

In one or more example methods, the sidelink reference signal configuration for positioning, such as PSCCH of the SL-TR for transmitting the sidelink reference signal configuration for positioning, comprises an identifier identifying the WD transmitting sidelink reference signals, such as the SL-Tx-WD ID.

In one or more example methods, the sidelink reference signal configuration for positioning, such as PSCCH of the SL-TR for transmitting the sidelink reference signal configuration for positioning, comprises one or more sidelink reference signals parameters for positioning, such as one or more of a time shift, a frequency shift, a number of symbols for transmitting sidelink reference signals for positioning in the shared resource, an activation pattern for transmitting in the symbols, a resource identifier, a muting option, a resource power (such as a transmission power to be used for transmitting in the resource), and a comb size of the shared resources for transmission if sidelink reference signals.

The number of symbols may be indicative of the number of symbols of the total number of symbols in the shared resource (or in the slot within the shared resource) that are allocated for transmission of sidelink reference signals for positioning. The activation pattern may be indicative of the pattern in which the symbols for transmitting sidelink reference signals are allocated. For example, the activation pattern may indicate that the sidelink reference signals for positioning are to be transmitted in non-contiguous symbols, such as symbols not being adjacent to each other. The resource identifier may identify the shared resources in which the sidelink reference signals for positioning are to be transmitted in accordance with the activation pattern and/or the number of symbols.

The muting option can be seen as a parameter indicating a pattern of unused, such as muted, resources, in which there is no transmission of sidelink reference signal for positioning. Assuming resources have been configured and/or assigned for positioning purposes, such as for transmission of sidelink reference signals for positioning. Additionally, there may be a muting option, such as a muting parameter, indicating a number of resources that are not to be used for positioning purposes. The muting option, such as the muting parameter, may be indicated as a bit pattern. In the bit pattern “0” means that in that particular time and/or occasion, the resources are unused (muted) for positioning purposes.

In one or more example methods, the sidelink reference signal configuration for positioning, such as PSCCH of the SL-TR for transmitting the sidelink reference signal configuration for positioning, comprises an indication being indicative of semi-persistent transmission of the sidelink reference signals for positioning, such as whether multiple time resources are allocated for the transmission of sidelink reference signals for positioning. The sidelink reference signal configuration may be indicative of whether the sidelink reference signal transmission is repetitive and/or whether different spatial filters (such as beams) are to be applied when receiving the sidelink reference signals.

In one or more example methods, the sidelink reference signal configuration for positioning, such as the RRC message, comprises an indication of the resource pool type. The illustrations in FIGS. 4-10, illustrate various implementations of resource pools to support positioning. The indication of the resource pool type may indicate whether a resource pool contains sidelink reference signals only. In one or more examples, the indication of the resource pool type can indicate whether a resource pool contains sidelink reference signals for positioning and the sidelink reference signal configuration for positioning, such as the configuration of the sidelink reference signals for positioning. In one or more examples, the indication of the resource pool type can indicate whether a resource pool contains sidelink reference signals for positioning, the sidelink reference signal configuration for positioning and/or a legacy SL-TR for communication.

In one or more example methods, the sidelink reference signal configuration for positioning, such as the PSCCH of the SL-TR for transmitting the sidelink reference signal configuration for positioning, comprises a required positioning measurement at the sidelink reference signal receiving WD, such as the SL-Rx-WD.

In one or more example methods, instead of being comprised in PSCCH and/or PSSCH, some information of the sidelink reference signal configuration for positioning, such as of the SL-TR for transmitting the sidelink reference signal configuration for positioning, may be associated with physical layer properties (such as a resource index, a scramble ID, such as a Radio Network Temporary Identifier (RNTI), etc.) to reduce control information overhead. In one or more example methods, a frequency offset of the sidelink reference signal comb structure is associated with an index of the PSCCH and PSSCH carrying the sidelink reference signal configuration, or a frequency position of the PSCCH and PSSCH. In one or more example methods, if the sidelink reference signal configuration comprises an indication pointing to sidelink reference signals for positioning allocated in a different slot than the slot comprising the configuration, the second slot can be associated with the physical layer property (such as the index or frequency position). In one or more example methods, instead of containing 2nd-stage SCI format differentiation information in the 1st-stage SCI, the scrambling ID can be applied to PSSCH carrying the sidelink reference signal configuration for positioning.

In one or more example methods, to support simultaneous transmission of both sidelink data and sidelink reference signals for positioning, apart from legacy 1st and 2nd-stage SCI, a new SCI format carrying sidelink reference signal configuration for positioning (which may be referred to as “3rd-stage SCI” or “SCI format 3”), such as an SCI pointing towards the resources for transmitting sidelink reference signals for positioning, is provided. While SCI format 2 carries control information related to SL data transmission, SCI format 3 may carry the sidelink reference signal configuration for positioning. The SCI format 3 may be comprised in the PSSCH.

In one or more example methods, an identifier for identifying the sidelink reference signals for positioning may be introduced. This identifier may indicate to the receiving WD which sidelink reference signals it should listen to or perform the positioning measurement on. The identifier for identifying the sidelink reference signals for positioning may be associated with one or more of an identifier identifying the sidelink reference signal transmitting WD, such as a SL-Tx-WD ID, a source ID and a cell RNTI (C-RNTI) in a connected mode WD. The source ID may correspond to the SL-Tx-WD ID or may be indicative of a plurality of sidelink reference signal transmitting WDs.

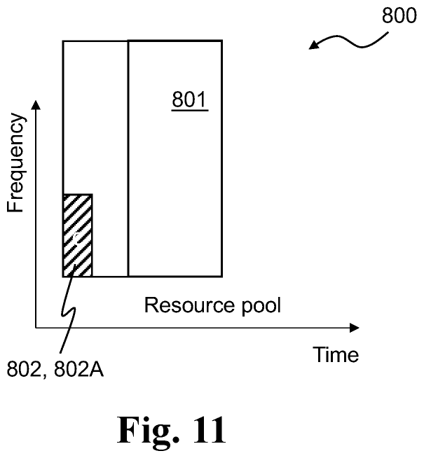

In one or more example methods, one SL-Tx-WD may transmit the sidelink reference signal configuration for a plurality of SL-Tx-WDs. Such a case is shown in FIG. 11, only one SL-Tx-WD of the plurality of SL-Tx-WDs transmits the sidelink reference signal configuration for positioning. The sidelink reference signal configuration for positioning comprises the sidelink reference signal configuration for a plurality or all of the SL-Tx-WDs transmitting sidelink reference signals for positioning to the same SL-Rx-WD. In other words, one of the SL-Tx-WD, which may herein be referred to as a Master WD, provides the configuration of the other SL-Tx-WDs. In one or more example methods, other WDs than the Master WD may transmit sidelink reference signal configurations for positioning by using the same SL-TR whenever the transmitted information of a SL-TR for transmitting the sidelink reference signal configuration for positioning is the same.

In one or more example methods, the radio network node may provide a resource pool configuration to one or more WDs, such as to one or more SL-Tx-WDs and/or one or more SL-Rx-WDs. In one or more example methods, the resource pool configuration may comprise an indication indicative of the supported SL-TR, such as supported SL-TR for carrying the sidelink reference signal configuration for positioning and supporter SL-TR carrying the sidelink reference signals for positioning. In one or more example methods, the resource pool configuration may comprise an indication indicative of the bitmap pattern of the SL-TR for transmitting the sidelink reference signal configuration for positioning and/or the bitmap pattern of the SL-TR for transmitting the sidelink reference signal for positioning.

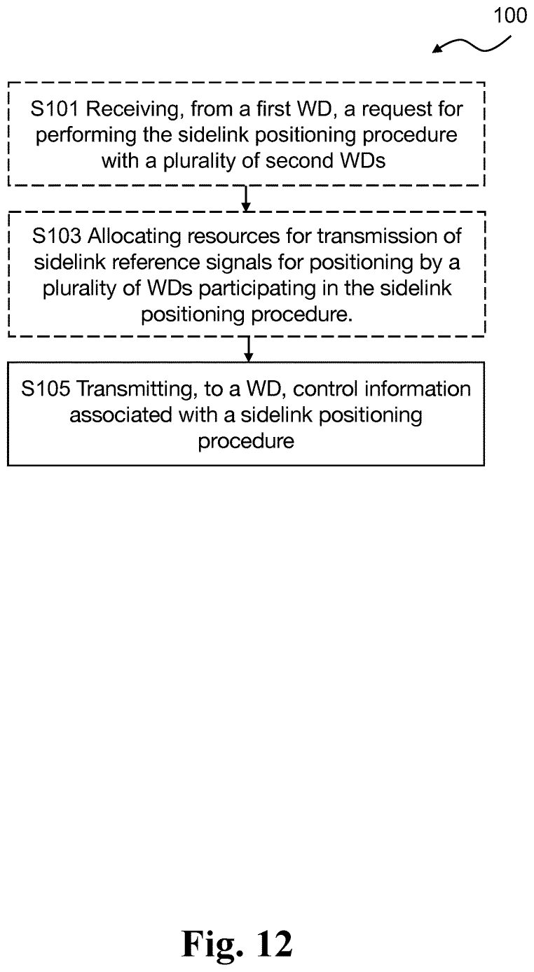

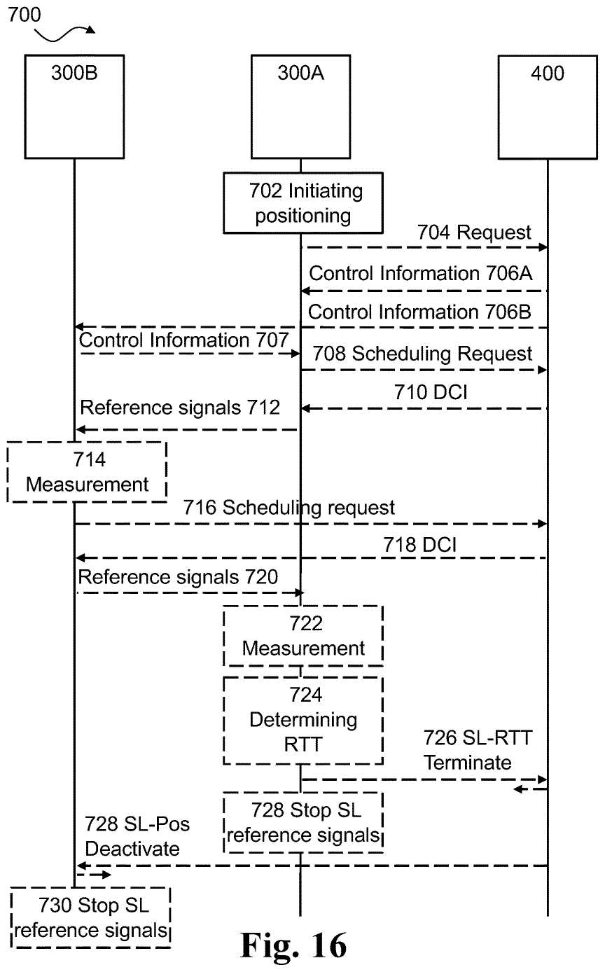

FIG. 12 shows a flow-chart of an example method 100, performed in a radio network node according to the disclosure, for configuring resources for sidelink reference signals for positioning. The radio network node is the radio network node disclosed herein, such as radio network node 400 of FIG. 1, and FIG. 16.

In one or more example methods, the method 100 comprises receiving S101, from a first WD, a request for performing the sidelink positioning procedure with a plurality of second WDs. In one or more example methods, the request comprises information identifying the first WD and the plurality of second WDs, such as a first WD ID and one or more second WD ID(s). The WD ID described herein corresponds to a UE ID. This step S101 corresponds to the step S201 performed by the first WD.

In one or more example methods, the method 100 comprises allocating S103 resources for transmission of sidelink reference signals for positioning, and/or resources for transmission of sidelink reference signal configuration for positioning, by a plurality of WDs participating in the sidelink positioning procedure. In one or more example methods, the allocation of the resources for transmission of sidelink reference signals for positioning is based on the request received from the first WD, such as based on the information identifying the first WD and the plurality of second WDs, such as a respective identifier for the first WD and the plurality of second WDs. In other words, allocating S103 the resources for transmission of sidelink reference signals for positioning by a plurality of WDs participating in the sidelink positioning procedure may be based on the request received from the first WD. The resources may be allocated according to one or more of the example resource allocations illustrated in FIGS. 4-11.

The method 100 comprises transmitting S105, to a wireless device, WD, control information associated with a sidelink positioning procedure. The control information is indicative of an allocation of resources for transmission of sidelink reference signals for positioning by a plurality of WDs participating in the sidelink positioning procedure. This step S105 corresponds to the step S203 performed by the first WD.

In one or more example methods, the control information is carried using higher layer signaling, such as Radio Resource Control (RRC) signaling, and/or lower layer signaling, such as downlink control information (DCI). In one or more example methods, the control information may be carried entirely using higher layer signaling. In one or more example methods, the control information may be carried entirely using lower layer signaling. In one or more example methods, the control information may be carried using a combination of higher layer signaling and lower layer signaling, such as using both RRC and DCI signaling. In other words, a first part of the control information may be carried by higher layer signaling and a second part of the control information may be carried by lower layer signaling.

In one or more example methods, the control information is indicative of a sidelink reference signal configuration for positioning associated with a respective WD of the plurality of WDs.

In one or more example methods, the sidelink reference signal configuration for positioning is indicative of one or more time resources for transmission of sidelink reference signals for positioning.

In one or more example methods, the sidelink reference signal configuration for positioning is indicative of whether the one or more time resources are semi-persistent, such as have a semi-persistent time-domain behavior, as described in 3GPP TS 38.214 v17.4.0. The time-resources for transmission may be time-resources for transmission of sidelink reference signals for positioning. The time resources being semi-persistent can herein be seen as the time resources being repetitive, configured via RRC signaling, and activated and/or deactivated using MAC signaling, and/or DCI. Using MAC signaling and/or DCI signaling to activate and/or deactivate the time resources allows for a faster activation and/or deactivation than periodic signaling when the time-domain behavior, such as the scheduling of time resources, is repetitive but intermittent.

In one or more examples herein, the semi-persistent time resources for transmission of sidelink reference signals are repeated within a reference signal transmit occasion. Thereby, the WD receiving the reference signal can try different spatial filters, such as receive beams, for receiving the reference signals for positioning. Examples of resource allocations having one or more time resources being semi-persistent are descried in relation to FIGS. 9 and 10 disclosed herein.

In one or more example methods, the sidelink reference signal configuration for positioning is indicative of required positioning measurements at a WD receiving the sidelink positioning reference signal. In other words, the sidelink reference signal configuration may be indicative of the type of positioning measurement that the WD receiving the sidelink reference signal is to perform. The sidelink reference signal configuration may for example indicate that the WD receiving the sidelink reference signals is to perform one or more of a Time Difference of Arrival (TDOA) measurement, a Round Trip Time (RTT) and a Reference Signal Time Difference (RSTD) measurement.

In one or more example methods, the sidelink reference signal configuration for positioning is indicative of one or more sidelink reference signal parameters for positioning. The one or more sidelink reference signal parameters for positioning may comprise one or more of a frequency offset for transmitting sidelink reference signals for positioning in a shared resource, a number of symbols for transmitting sidelink reference signals for positioning in the shared resource, an activation pattern for transmitting in the symbols, a resource identifier (ID), a muting option, a resource power, a comb size, an indication indicative of the resource pool type, and a time offset for transmitting sidelink reference signals for positioning in the shared resource.

The number of symbols may be indicative of the number of symbols of the total number of symbols in the shared resource that are allocated for transmission of sidelink reference signals for positioning. The activation pattern may be indicative of the pattern in which the symbols for transmitting sidelink reference signals are allocated. For example, the activation pattern may indicate that the sidelink reference signals for positioning are to be transmitted in non-contiguous symbols, such as symbols not being adjacent to each other. The resource identifier may identify the shared resources in which the sidelink reference signals for positioning are to be transmitted in accordance with the activation pattern and/or the number of symbols.

In one or more example methods, the one or more sidelink reference signal parameters for positioning are associated with an identifier identifying a WD configured to transmit sidelink reference signals for positioning, such as the SL-Tx-WD ID. A plurality of transmitting WDs may have respective sidelink reference signal parameters being indicative of respective allocated resources for transmission of sidelink reference signals for positioning. The sidelink reference signal parameters may comprise the identifier identifying the WD associated with the one or more sidelink reference signal parameters. In one or more example methods, a first set of sidelink reference signal parameters may be associated with a first transmitting WD and may comprise a first identifier identifying the first WD. A second set of sidelink reference signal parameters may be associated with a second transmitting WD and may comprise a second identifier identifying the second WD.

In one or more example methods, the control information is indicative of dedicated resources for transmission of sidelink reference signal configurations for positioning for the plurality of WDs respectively. The dedicated resources for transmission of sidelink reference signal configurations is to be used by a WD transmitting sidelink reference signals in the sidelink for informing a WD receiving the sidelink reference signals, such as the target WD, about the sidelink reference signal configuration. The dedicated resources for transmission of sidelink reference signal configurations may be allocated prior to the shared resource for transmitting sidelink reference signals and allows the transmitting WD to inform the receiving WD of the resources in which the sidelink reference signals will be transmitted prior to the transmission. This may for example be the case when the sidelink positioning procedure of the target WD is initiated by a WD communicating in the sidelink without the involvement of the radio network node, such as in resource allocation Mode 2. The WD initiating the sidelink positioning procedure can herein be referred to as an initiator or initiating WD.

In one or more example methods, the dedicated resources for transmission of sidelink reference signal configurations for positioning are allocated in a same slot and in different frequency resources. In other words, a plurality of sidelink reference signal transmitting WDs, and/or initiating WDs, may have their respective dedicated resources for transmission of sidelink reference signal configurations allocated in the same slot but separated in frequency, such as disclosed in relation to FIGS. 4-7, and 9-11.

In one or more example methods, the control information is indicative of an identifier identifying a WD transmitting a sidelink reference signal for positioning. The identifier identifying the WD transmitting the sidelink reference signal for positioning can be used by the first WD, such as a WD receiving the sidelink reference signal, for determining the resources allocated for transmission of sidelink reference signals. The resources may be resources associated with the transmitting WD, such as dedicated resources to be used by the transmitting WD for transmitting sidelink reference signals.

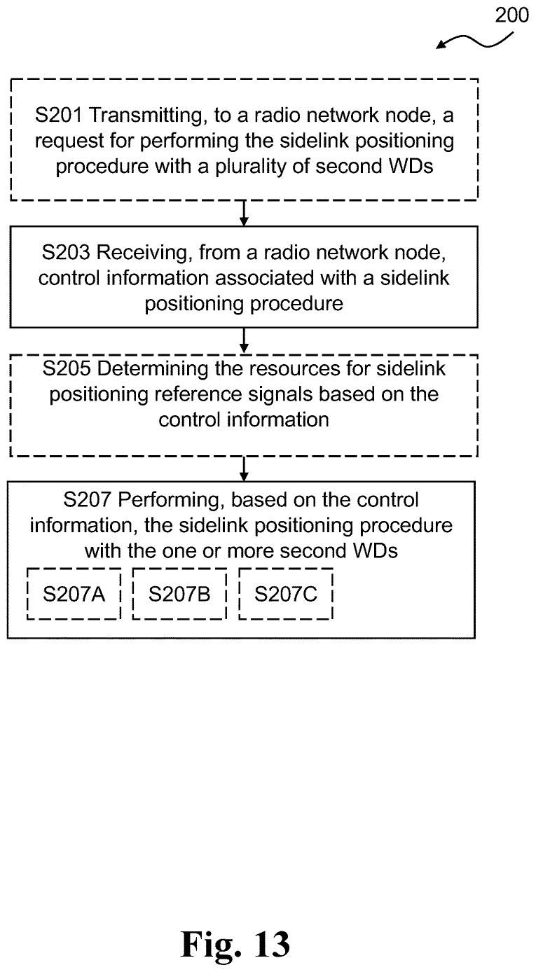

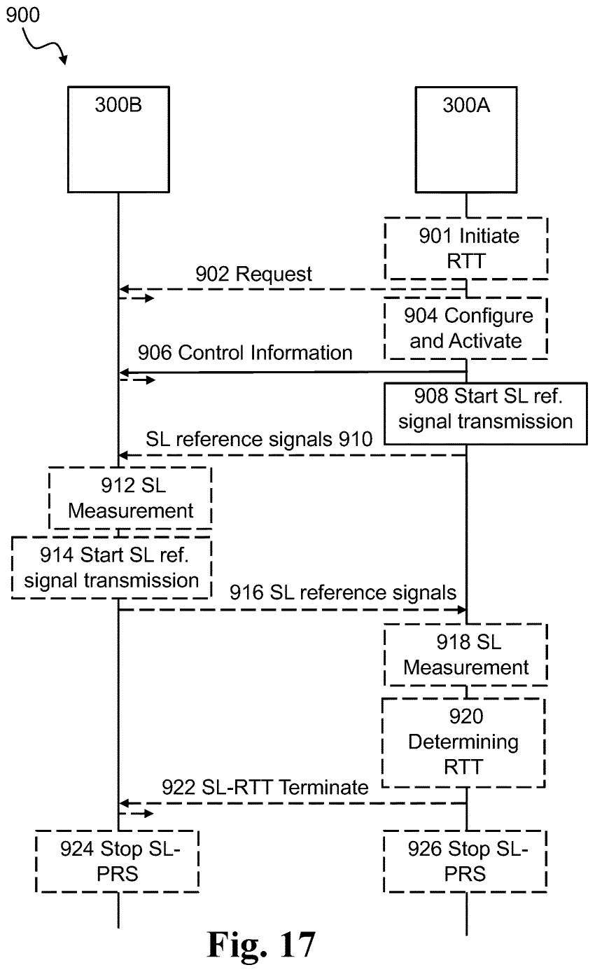

FIG. 13 shows a flow-chart of an example method 200, performed in a first wireless device, WD, according to the disclosure, for communicating sidelink reference signals for positioning with one or more second WDs. The first WD is the first WD disclosed herein, such as first WD 300, 300A of FIG. 1, FIG. 16, and FIG. 17.

In one or more example methods, the method 200 comprises transmitting S201, to the radio network node, a request for performing the sidelink positioning procedure with a plurality of second WDs. The request may comprise information identifying the first WD and the plurality of second WDs, such as a respective identifier for the first WD and the plurality of second WDs.

The method 100 comprises receiving S203, from a radio network node, control information associated with a sidelink positioning procedure. The control information is indicative of an allocation of resources for transmission of sidelink reference signals for positioning by a plurality of WDs participating in a sidelink positioning procedure. The control information can be comprised in DCI.

In one or more example methods, the control information is indicative of respective dedicated resources for transmission of sidelink reference signal configurations for positioning by the plurality of WDs. The dedicated resources may be specific for each WD transmitting sidelink reference signals, such as specific for each SL-Tx-WD.

In one or more example methods, the respective dedicated resources for transmission of sidelink reference signal configurations for positioning are allocated in a same slot and in different frequency resources. In other words, a plurality of sidelink reference signal transmitting WDs, and/or initiating WDs, may have their respective dedicated resources for transmission of sidelink reference signal configurations allocated in the same slot but separated in frequency, such as disclosed in relation to FIGS. 4-7, and 9-11.

In one or more example methods, the sidelink reference signal configuration for positioning is indicative of an identifier identifying a WD transmitting a sidelink reference signal for positioning.

In one or more example methods, the method 200 comprises determining S205 the resources for sidelink positioning reference signals based on the control information, such as based on the identifier identifying the WD transmitting the sidelink reference signal for positioning.

The method 100 comprises performing S207, based on the control information, the sidelink positioning procedure with the one or more second WDs.

In one or more example methods, the sidelink reference signal configuration for positioning is indicative of one or more time resources for transmission of sidelink reference signals for positioning.

In one or more example methods, the sidelink reference signal configuration for positioning is indicative of whether the one or more time resources are semi-persistent, such as have a semi-persistent time-domain behavior, as described in 3GPP TS 38.214 v17.4.0. The time-resources for transmission may be time-resources for transmission of sidelink reference signals for positioning. The time resources being semi-persistent can herein be seen as the time resources being repetitive, configured via RRC signaling, and activated and/or deactivated using MAC signaling and/or DCI. Using MAC signaling and/or DCI signaling to activate and/or deactivate the time resources allows for a faster activation and/or deactivation than periodic signaling when the time-domain behavior, such as the scheduling of time resources, is repetitive but intermittent.

In one or more examples herein, the semi-persistent time resources for transmission of sidelink reference signals are repeated within a reference signal transmit occasion. Thereby, the WD receiving the reference signal can try different spatial filters, such as receive beams, for receiving the reference signals for positioning. Examples of resource allocations having one or more time resources being semi-persistent are described in relation to FIGS. 9 and 10 disclosed herein.

In one or more example methods, the sidelink reference signal configuration for positioning is indicative of required positioning measurements at a WD receiving the sidelink positioning reference signal. In other words, the sidelink reference signal configuration may be indicative of the type of positioning measurement that the WD receiving the sidelink reference signal is to perform. The sidelink reference signal configuration may for example indicate that the WD receiving the sidelink reference signals is to perform one or more of a TDOA measurement and a RSTD measurement.

In one or more example methods, the sidelink reference signal configuration for positioning is indicative of one or more sidelink reference signal parameters for positioning. In one or more example methods, the one or more sidelink reference signal parameters for positioning comprise one or more of a frequency offset for transmitting sidelink reference signals for positioning in a shared resource, a number of symbols for transmitting sidelink reference signals for positioning in the shared resource, an activation pattern for transmitting in the symbols, a resource identifier, ID, a muting option, a resource power, a comb size, an indication indicative of the resource pool type, and a time offset for transmitting sidelink reference signals for positioning in the shared resource. The number of symbols may be indicative of the number of symbols of the total number of symbols in the shared resource (or in the slot within a shared resource) that are allocated for transmission of sidelink reference signals for positioning. The activation pattern may be indicative of the pattern in which the symbols for transmitting sidelink reference signals are allocated. For example, the activation pattern may indicate that the sidelink reference signals for positioning are to be transmitted in non-contiguous symbols, such as symbols not being adjacent to each other. The resource identifier may identify the shared resources in which the sidelink reference signals for positioning are to be transmitted in accordance with the activation pattern and/or the number of symbols. In one or more example methods, the activation pattern may be indicative of the pattern in which the slots within a resource pool for transmitting sidelink reference signals are allocated.

In one or more example methods, the one or more sidelink reference signal parameters for positioning are associated with an identifier identifying a WD configured to transmit sidelink reference signals for positioning.

In one or more example methods, the first WD is a receiving WD, such as a SL-Rx-WD. In one or more example methods, performing S207 the sidelink positioning procedure comprises monitoring S207A sidelink reference signals for positioning in the indicated resources for transmission of sidelink reference signals for positioning by the plurality of second WDs.

In one or more example methods, the first WD is a transmitting WD, such as a SL-Tx-WD. In one or more example methods, performing S207 the sidelink positioning procedure comprises transmitting S207C sidelink reference signals for positioning in the resources for transmission of sidelink reference signals for positioning as indicated in the control information.

In one or more example methods, performing S207 the sidelink positioning procedure comprises transmitting S207B, to a second WD, control information indicative of the sidelink reference signal configuration for positioning in a dedicated resource for transmission of sidelink reference signal configurations for positioning associated with the first WD.

In one or more example methods, the transmission of control information and the transmission of sidelink reference signals for positioning are within a same sidelink resource pool.

In one or more example methods, the transmission of control information and the transmission of sidelink reference signals for positioning are in separate sidelink resource pools.

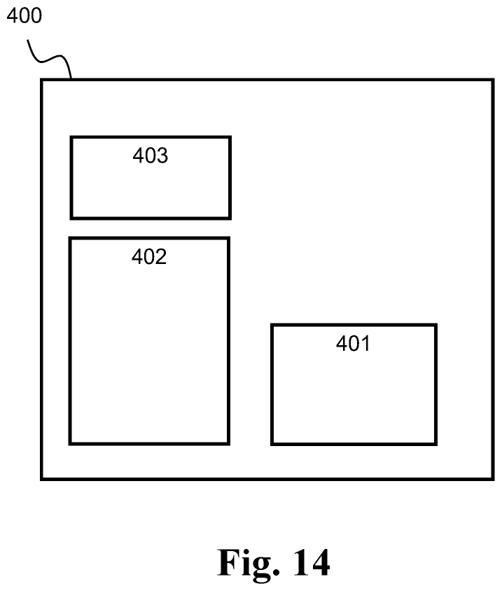

FIG. 14 shows a block diagram of an example radio network node 400 according to the disclosure. The radio network node 400 comprises memory circuitry 401, processor circuitry 402, and a wireless interface 403. The radio network node 400 may be configured to perform any of the methods disclosed in FIG. 12. In other words, the radio network node 400 may be configured for configuring resources for sidelink reference signals for positioning.

The radio network node 400 is configured to communicate with a wireless device, WD, such as the WD disclosed herein, using a wireless communication system.

The wireless interface 403 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

The radio network node 400 is configured to transmit (such as, via the wireless interface 403), to the WD, control information associated with a sidelink positioning procedure. The control information is indicative of an allocation of resources for transmission of sidelink reference signals for positioning by a plurality of WDs participating in the sidelink positioning procedure.

Processor circuitry 402 is optionally configured to perform any of the operations disclosed in FIG. 12 (such as any one or more of: S101, S103, S105). The operations of the radio network node 400 may be embodied in the form of executable logic routines (for example, lines of code, software programs, etc.) that are stored on a non-transitory computer readable medium (for example, memory circuitry 401) and are executed by processor circuitry 402.

Furthermore, the operations of the radio network node 400 may be considered a method that the radio network node 400 is configured to carry out. Also, while the described functions and operations may be implemented in software, such functionality may also be carried out via dedicated hardware or firmware, or some combination of hardware, firmware and/or software. Memory circuitry 401 may be one or more of: a buffer, a flash memory, a hard drive, a removable media, a volatile memory, a non-volatile memory, a random access memory (RAM), and any other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 14). Memory circuitry 401 is considered a non-transitory computer readable medium.

Memory circuitry 401 may be configured to store information, such as control information, resource allocations, and/or sidelink reference signal configurations, in a part of the memory.

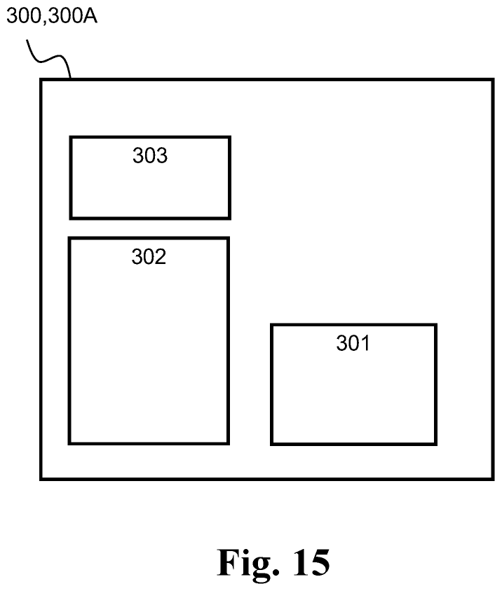

FIG. 15 shows a block diagram of an example wireless device 300, 300A according to the disclosure. The wireless device 300, 300A comprises memory circuitry 301, processor circuitry 302, and a wireless interface 303. The wireless device 300, 300A may be configured to perform any of the methods disclosed in FIG. 13. In other words, the wireless device 300 may be configured for communicating sidelink reference signals for positioning with one or more second WDs.

The wireless device 300 is configured to communicate with a radio network node, such as the radio network node disclosed herein, using a wireless communication system.

The wireless device 300 is configured to receive (such as, via the wireless interface 303), from the radio network node, control information associated with a sidelink positioning procedure. The control information is indicative of an allocation of resources for transmission of sidelink reference signals for positioning by a plurality of WDs participating in a sidelink positioning procedure.

The wireless device 300 is configured to perform (such as, processor circuitry 302), based on the control information, the sidelink positioning procedure with the one or more second WDs.

The wireless interface 303 is configured for wireless communications via a wireless communication system, such as a 3GPP system, such as a 3GPP system supporting one or more of: New Radio, NR, Long Term Evolution, LTE, Narrow-band IoT, NB-IoT, and Long Term Evolution-enhanced Machine Type Communication, LTE-M, and 3GPP system operated in licensed bands or unlicensed bands.

The wireless device 300 is optionally configured to perform any of the operations disclosed in FIG. 13 (such as any one or more of: S201, S203, S205, S207). The operations of the wireless device 300 may be embodied in the form of executable logic routines (for example, lines of code, software programs, etc.) that are stored on a non-transitory computer readable medium (for example, memory circuitry 301) and are executed by processor circuitry 302.

Furthermore, the operations of the wireless device 300 may be considered a method that the wireless device 300 is configured to carry out. Also, while the described functions and operations may be implemented in software, such functionality may also be carried out via dedicated hardware or firmware, or some combination of hardware, firmware and/or software.

Memory circuitry 301 may be one or more of: a buffer, a flash memory, a hard drive, a removable media, a volatile memory, a non-volatile memory, a random access memory (RAM), and any other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 15). Memory circuitry 301 is considered a non-transitory computer readable medium.

Memory circuitry 301 may be configured to store information, such as control information, resource allocations, and/or sidelink reference signal configurations, in a part of the memory.

FIG. 16 is a signaling diagram illustrating an example communication between a radio network node 400, a first wireless device 300A and a second wireless device 300B, for configuring resources for sidelink reference signals for positioning, according to this disclosure. In FIG. 16, one or both of the first wireless device 300A and the second wireless device 300B in the figure represent multiple first and/or second WDs transmitting reference signals, such as reference signals for positioning. The example communication shown in FIG. 16 describes a resource allocation mode 1, in which the radio network node 400, such as an eNB or gNB, schedules sidelink resource(s) to be used by the WDs 300A, 300B for communication of sidelink reference signals for positioning. The resource allocation may be dynamically signaled from the radio network node. The positioning procedure may be initiated by a WD participating in the sidelink communication, such as without involvement from a positioning node, such as an LMF. The resource allocation may be activated via MAC signaling, such as via a MAC control element (CE), or DCI for semi-static transmissions, and via RRC signaling for periodic static transmission.

The first WD 300A may initiate 702 a sidelink positioning procedure, such as an RTT measurement procedure, between the first WD 300A and the second WD 300B.

The first WD 300A may send a request 704 to the radio network node 400, such as a request for performing the sidelink positioning procedure with one or more second WDs 300B. The request may comprise identifiers identifying the WDs participating in the sidelink positioning procedure, such as identifiers identifying the first WD 300A and the second WD 300B. The signaling 704 corresponds to the method step S101 performed by the radio network node 400 and method step S201 performed by the first WD 300A.

The radio network node 400 transmits control information 706A to the first WD 300A and/or control information 706B to the second WD 300B. In one or more example methods, the radio network node may transmit either control information 706A to the first WD 300A and/or control information 706B to the second WD 300B. The control information 706A, 706B may be associated with the sidelink positioning procedure, wherein the control information is indicative of an allocation of resources for transmission of sidelink reference signals for positioning by a plurality of WDs 300A, 300B participating in the sidelink positioning procedure. The control information 706A may indicate to the first WD 300A that the first WD 300A is the sidelink reference signal transmitting WD, such as the SL-Tx-WD. Consequently, the second WD 300B is the sidelink reference signal receiving WD, such as the SL-Rx-WD. The control information 706B may indicate to the second WD 300B that the second WD 300B is the sidelink reference signal transmitting WD, such as the SL-Tx-WD. Consequently, the first WD 300A is the sidelink reference signal receiving WD, such as the SL-Rx-WD. The signaling 706A, 706B may be transmitted using higher layer signaling, such as RRC signaling. In one or more example methods, the WD receiving the control information may forward the control information to the other WD. For example, if the second WD 300B receives the control information 706B, the second WD 300B may forward the control information 707 to the first WD 300A. The control information 707 may be transmitted using MAC signaling or SCI signaling. The signaling 706A and 706B corresponds to the method steps S105 performed by the radio network node 400 and method step S203 performed by the first WD.

In one or more examples, the first WD 300A is a sidelink reference signal transmitting WD and the second WD 300B is a sidelink reference signal receiving WD. The first WD 300A may send a scheduling request 708 to the radio network node 400. The radio network node 400 may respond to the scheduling request 708 by sending, to the first WD 300A a DCI 710, the DCI 710 being indicative of the control information, such as being indicative of a subset of the control information. Based on the control information the first WD may transmit sidelink reference signals for positioning 712 to the second WD 300B. The second WD 300B may perform measurements 714 on the received sidelink reference signals for positioning 712. The signaling 710 is similar to the method steps S105 performed by the radio network node 400 and method step S203 performed by the first WD. The signaling 712 corresponds to method step S207B performed by the first WD.

In one or more examples, the first WD 300A is a sidelink reference signal receiving WD and the second WD 300B is a sidelink reference signal transmitting WD. The second WD 300B may send a scheduling request 716 to the radio network node 400. The radio network node 400 may respond to the scheduling request 716 by sending, to the second WD 300B a DCI 718, the DCI 718 being indicative of the control information, such as being indicative of a subset of the control information. Based on the control information the second WD 300B may transmit sidelink reference signals for positioning 720 to the first WD 300A. The first WD 300A may perform measurements 722 on the received sidelink reference signals for positioning 720. The signaling 720 corresponds to method step S207A performed by the first WD.

In one or more examples, the first WD 300A may perform ranging, such as may determine an RTT 724, based on the measurement 722.

In one or more examples, the initiating WD, such as the first WD 300A sends a message terminating the sidelink positioning procedure, such as a SL-RTT terminate message 726, to the radio network node 400.

Once the first WD has sent the message terminating the sidelink positioning procedure, the first WD 300A may stop 728 transmitting and/or measuring the sidelink reference signals for positioning.

The radio network node 400 may transmit to the second WD 300B, a sidelink positioning deactivation message 730 to the second WD 300B. The sidelink positioning deactivation message 730 may comprise an identifier identifying the WD transmitting the sidelink reference signals for positioning, to indicate to the second WD 300B that it is to stop transmitting and/or measuring the sidelink reference signals for positioning from the identified WD.

Based on the received sidelink positioning deactivation message, the second WD 300B may stop 732 transmitting and/or measuring the sidelink reference signals for positioning.

FIG. 17 is a signaling diagram illustrating an example communication between a first wireless device 300A and a second wireless device 300B, for configuring resources for sidelink reference signals for positioning, according to this disclosure. In FIG. 17, one or both of the first wireless device 300A and the second wireless device 300B in the figure represent multiple WDs 300 transmitting reference signals, such as reference signals for positioning. The example communication shown in FIG. 17 describes a resource allocation mode 2, in which an initiating WD, in this case the first WD 300A schedules sidelink resource(s) to be used by the WDs 300A, 300B for communication of sidelink reference signals for positioning. The sidelink reference signal configuration, such as the resource allocation for transmitting sidelink reference signals for positioning, may be signaled from the initiating WD, such as the first WD 300A, to the second WD 300B. The positioning procedure may be initiated by a WD participating in the sidelink communication, such as the first WD 300A, without involvement from a positioning node, such as an LMF. The activation and/or deactivation of the resource allocation for sidelink reference signals may be activated via MAC signaling, such as via a MAC CE, or sidelink control information (SCI).

The first WD 300A may initiate 901 a sidelink positioning procedure, such as an RTT measurement procedure, between the first WD 300A and the second WD 300B.

The first WD 300A may send a request 902 to the second WD 300B, such as a request for performing the sidelink positioning procedure, such as a SL RTT procedure with one or more second WDs 300B. The request may comprise identifiers identifying the WDs participating in the sidelink positioning procedure, such as identifiers identifying the first WD 300A and the second WD 300B.

The first WD 300A may configure and/or activate the sidelink reference signal configuration, such as resource allocation.

The first WD 300A transmits control information 906 to the second WD 300B. The control information 906 may be associated with the sidelink positioning procedure, wherein the control information is indicative of an allocation of resources for transmission of sidelink reference signals for positioning by the first WD 300A and/or the second WD 300B participating in the sidelink positioning procedure. The control information 906 may indicate to the second WD 300B the WD out of the first WD 300A and second WD 300B that is the sidelink reference signal transmitting WD, such as the SL-Tx-WD. Consequently, the other one of the first WD 300A and the second WD 300B is the sidelink reference signal receiving WD, such as the SL-Rx-WD. The signaling 906 may be transmitted using a MAC CE or SCI. The signaling 906 corresponds to the method step S207B performed by the first WD.

In one or more examples, the first WD 300A is a sidelink reference signal transmitting WD and the second WD 300B is a sidelink reference signal receiving WD. The first WD 300A may start 908 sidelink reference signal transmission and may transmit sidelink reference signals for positioning 910 to the second WD 300B. The second WD 300B may perform measurements 912 on the received sidelink reference signals for positioning 910. The signaling 910 corresponds to method step S207C performed by the first WD.

In one or more examples, the first WD 300A is the sidelink reference signal receiving WD and the second WD 300B is the sidelink reference signal transmitting WD. The second WD 300B may start 914 sidelink reference signal transmission and may transmit sidelink reference signals for positioning 916 to the first WD 300A. The transmission of 916 may also be accompanied and/or followed by the positioning measurement results, obtained in 912. The first WD 300A may perform measurements 918 on the received sidelink reference signals for positioning 916. The signaling 916 corresponds to method step S207A performed by the first WD.

In one or more examples, the first WD 300A may perform ranging, such as may determine an RTT 920, based on the measurement 918.

In one or more examples, the initiating WD, such as the first WD 300A sends a message 922 terminating the sidelink positioning procedure, such as a SL-RTT terminate message, to the second WD 300B. The message 922 may comprise an identifier identifying the WD transmitting the sidelink reference signals for positioning, to indicate to the second WD 300B that it is to stop transmitting and/or measuring the sidelink reference signals for positioning from the identified WD.

Once the first WD has sent the message terminating the sidelink positioning procedure, the first WD 300A may stop 926 transmitting and/or measuring the sidelink reference signals for positioning.

Based on the received message 922, the second WD 300B may stop 924 transmitting and/or measuring the sidelink reference signals for positioning.

Examples of methods and products (radio network node and wireless device) according to the disclosure are set out in the following items:

Item 1. A method, performed in a radio network node, for configuring resources for sidelink reference signals for positioning, wherein the method comprises:
transmitting (S105), to a WD, control information associated with a sidelink positioning procedure, wherein the control information is indicative of an allocation of resources for transmission of sidelink reference signals for positioning by a plurality of WDs participating in the sidelink positioning procedure.

Item 2. The method according to Item 1, wherein the control information is carried using higher layer signaling and/or lower layer signaling.

Item 3. The method according to Item 1 or 2, wherein the control information is indicative of a sidelink reference signal configuration for positioning associated with a respective WD of the plurality of WDs.

Item 4. The method according to Item 3, wherein the sidelink reference signal configuration for positioning is indicative of one or more time resources for transmission of sidelink reference signals for positioning.

Item 5. The method according to Item 4, wherein the sidelink reference signal configuration for positioning is indicative of whether the one or more time resources are semi-persistent.

Item 6. The method according to any one of the Items 3 to 5, wherein the sidelink reference signal configuration for positioning is indicative of required positioning measurements at a WD receiving the sidelink positioning reference signal.

Item 7. The method according to any one of the Items 3 to 6, wherein the sidelink reference signal configuration for positioning is indicative of one or more sidelink reference signal parameters for positioning.

Item 8. The method according to Item 7, wherein the one or more sidelink reference signal parameters for positioning comprise one or more of a frequency offset for transmitting sidelink reference signals for positioning in a shared resource, a number of symbols for transmitting sidelink reference signals for positioning in the shared resource, an activation pattern for transmitting in the symbols, a resource identifier, a muting option, a resource power, a comb size, an indication indicative of the resource pool type, and a time offset for transmitting sidelink reference signals for positioning in the shared resource.

Item 9. The method according to Item 8, wherein the one or more sidelink reference signal parameters for positioning are associated with an identifier identifying a WD configured to transmit sidelink reference signals for positioning.

Item 10. The method according to any one of the previous Items, wherein the control information is indicative of dedicated resources for transmission of sidelink reference signal configurations for positioning for the plurality of WDs respectively.

Item 11. The method according to Item 10, wherein the dedicated resources for transmission of sidelink reference signal configurations for positioning are allocated in a same slot and in different frequency resources.

Item 12. The method according to any of the Items 3 to 11, wherein the control information is indicative of an identifier identifying a WD transmitting a sidelink reference signal for positioning.

Item 13. The method according to any one of the previous Items, wherein the method comprises:
receiving (S101), from a first WD, a request for performing the sidelink positioning procedure with a plurality of second WDs.

Item 14. The method according to Item 13, wherein the request comprises information identifying the first WD and the plurality of second WDs.

Item 15. The method according to any one of the Items 13 to 14, wherein the allocation of the resources for transmission of sidelink reference signals for positioning is based on the request received from the first WD.

Item 16. The method according to any one of the previous Items, wherein the method comprises:
allocating (S103) resources for transmission of sidelink reference signals for positioning by a plurality of WDs participating in the sidelink positioning procedure.

Item 17. A method, performed in a first wireless device, WD, for communicating sidelink reference signals for positioning with one or more second WDs, wherein the method comprises:
receiving (S203), from a radio network node, control information associated with a sidelink positioning procedure, wherein the control information is indicative of an allocation of resources for transmission of sidelink reference signals for positioning by a plurality of WDs participating in a sidelink positioning procedure, and
performing (S207), based on the control information, the sidelink positioning procedure with the one or more second WDs.

Item 18. The method according to Item 17, wherein the control information is indicative of respective dedicated resources for transmission of sidelink reference signal configurations for positioning by the plurality of WDs.

Item 19. The method according to Item 18, wherein the respective dedicated resources for transmission of sidelink reference signal configurations for positioning are allocated in a same slot and in different frequency resources.

Item 20. The method according to any one of the Items 18 to 19, wherein the sidelink reference signal configuration for positioning is indicative of an identifier identifying a WD transmitting a sidelink reference signal for positioning.

Item 21. The method according to Item 20, wherein the method comprises:
determining (S205) the resources for sidelink positioning reference signals based on the identifier.

Item 22. The method according to any one of the Items 18 to 21, wherein the sidelink reference signal configuration for positioning is indicative of one or more time resources for transmission of sidelink reference signals for positioning.

Item 23. The method according to Item 22, wherein the sidelink reference signal configuration for positioning is indicative of whether the one or more time resources are semi-persistent.

Item 24. The method according to any one of the Items 18 to 23, wherein the sidelink reference signal configuration for positioning is indicative of required positioning measurements at a WD receiving the sidelink positioning reference signal.

Item 25. The method according to any one of the Items 18 to 24, wherein the sidelink reference signal configuration for positioning is indicative of one or more sidelink reference signal parameters for positioning.

Item 26. The method according to Item 25, wherein the one or more sidelink reference signal parameters for positioning comprise one or more of: a frequency offset for transmitting sidelink reference signals for positioning in a shared resource, a number of symbols for transmitting sidelink reference signals for positioning in the shared resource, an activation pattern for transmitting in the symbols, a resource identifier, a muting option, a resource power, a comb size, an indication indicative of the resource pool type, and a time offset for transmitting sidelink reference signals for positioning in the shared resource.

Item 27. The method according to Item 26, wherein the one or more sidelink reference signal parameters for positioning are associated with an identifier identifying a WD configured to transmit sidelink reference signals for positioning.

Item 28. The method according to any of the Items 17 to 27, wherein the method comprises:
transmitting (S201), to the radio network node, a request for performing the sidelink positioning procedure with a plurality of second WDs.

Item 29. The method according to Item 28, wherein the request comprises information identifying the first WD and the plurality of second WDs.

Item 30. The method according to any one of the Items 17 to 29, wherein the first WD is a receiving WD and wherein performing (S207) the sidelink positioning procedure comprises monitoring (S207A) sidelink reference signals for positioning in the indicated resources for transmission of sidelink reference signals for positioning by the plurality of second WDs.

Item 31. The method according to any one of the Items 17 to 30, wherein the first WD is a transmitting WD and wherein performing (S207) the sidelink positioning procedure comprises transmitting (S207C) sidelink reference signals for positioning in the resources for transmission of sidelink reference signals for positioning as indicated in the control information.

Item 32. The method according to Item 31 and one or more of Items 18 to 19, wherein performing (S207) the sidelink positioning procedure comprises transmitting (S207B), to a second WD, control information indicative of the sidelink reference signal configuration for positioning in a dedicated resource for transmission of sidelink reference signal configurations for positioning associated with the first WD.

Item 33. The method according to Item 31 and 32, wherein the transmission of control information and the transmission of sidelink reference signals for positioning are within a same sidelink resource pool.

Item 34. The method according to Item 31 and 32, wherein the transmission of control information and the transmission of sidelink reference signals for positioning are in separate sidelink resource pools.

Item 35. A radio network node comprising memory circuitry, processor circuitry, and a wireless interface, wherein the radio network node is configured to perform any of the methods according to any of Items 1-16.

Item 36. A wireless device comprising memory circuitry, processor circuitry, and a wireless interface, wherein the wireless device is configured to perform any of the methods according to any of Items 17-34.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that the FIGS. 1-15 comprise some circuitries or operations which are illustrated with a solid line and some circuitries, components, features, or operations which are illustrated with a dashed line. Circuitries or operations which are comprised in a solid line are circuitries, components, features, or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes, and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed in a radio network node, for configuring resources for sidelink reference signals for positioning, wherein the method comprises:
transmitting, to a wireless device (WD) control information associated with a sidelink positioning procedure, wherein the control information is indicative of an allocation of resources for transmission of sidelink reference signals for positioning by a plurality of WDs participating in the sidelink positioning procedure.

2. The method according to claim 1, wherein the control information is carried using higher layer signaling and/or lower layer signaling.

3. The method according to claim 1, wherein the control information is indicative of a sidelink reference signal configuration for positioning associated with a respective WD of the plurality of WDs.

4. The method according to claim 3, wherein the sidelink reference signal configuration for positioning is indicative of one or more time resources for transmission of sidelink reference signals for positioning.

5. The method according to claim 4, wherein the sidelink reference signal configuration for positioning is indicative of whether the one or more time resources are semi-persistent.

6. The method according to claim 3, wherein the sidelink reference signal configuration for positioning is indicative of required positioning measurements at a WD receiving the sidelink positioning reference signal.

7. The method according to claim 3, wherein the sidelink reference signal configuration for positioning is indicative of one or more sidelink reference signal parameters for positioning.

8. The method according to claim 7, wherein the one or more sidelink reference signal parameters for positioning comprise one or more of a frequency offset for transmitting sidelink reference signals for positioning in a shared resource, a number of symbols for transmitting sidelink reference signals for positioning in the shared resource, an activation pattern for transmitting in the symbols, a resource identifier, a muting option, a resource power, a comb size, an indication indicative of the resource pool type, and a time offset for transmitting sidelink reference signals for positioning in the shared resource.

9. The method according to claim 8, wherein the one or more sidelink reference signal parameters for positioning are associated with an identifier identifying a WD configured to transmit sidelink reference signals for positioning.

10. The method according to claim 1, wherein the control information is indicative of dedicated resources for transmission of sidelink reference signal configurations for positioning for the plurality of WDs respectively.

11. The method according to claim 10, wherein the dedicated resources for transmission of sidelink reference signal configurations for positioning are allocated in a same slot and in different frequency resources.

12. The method according to claim 3, wherein the control information is indicative of an identifier identifying a WD transmitting a sidelink reference signal for positioning.

13. The method according to claim 1, wherein the method comprises:
receiving, from a first WD, a request for performing the sidelink positioning procedure with a plurality of second WDs.

14. The method according to claim 13, wherein the request comprises information identifying the first WD and the plurality of second WDs.

15. The method according to claim 13, wherein the allocation of the
resources for transmission of sidelink reference signals for positioning is based on the request received from the first WD.

16. The method according to claim 1, wherein the method comprises:
allocating resources for transmission of sidelink reference signals for positioning by a plurality of WDs participating in the sidelink positioning procedure.

17. A method, performed in a first wireless device (WD) for communicating sidelink reference signals for positioning with one or more second WDs, wherein the method comprises:
receiving, from a radio network node, control information associated with a sidelink positioning procedure, wherein the control information is indicative of an allocation of resources for transmission of sidelink reference signals for positioning by a plurality of WDs participating in a sidelink positioning procedure, and
performing, based on the control information, the sidelink positioning procedure with the one or more second WDs.

18. The method according to claim 17, wherein the control information is indicative of respective dedicated resources for transmission of sidelink reference signal configurations for positioning by the plurality of WDs.

19. The method according to claim 18, wherein the respective dedicated resources for transmission of sidelink reference signal configurations for positioning are allocated in a same slot and in different frequency resources.

20. The method according to claim 18, wherein the sidelink reference signal configuration for positioning is indicative of an identifier identifying a WD transmitting a sidelink reference signal for positioning.

21-36. (canceled)
